(19) United States
(12) Patent Application Publication
(10) Pub. No.: US 2014/0002852 A1
(43) Pub. Date: Jan. 2, 2014

(54) OBTAINING DOCUMENTS REMOTELY VIA PRINTER

(71) Applicants: Michael F. Fallon, Tiverton, RI (US); Myles J. Wilde, Charlestown, MA (US); Matthew Adiletta, Bolton, MA (US)

(72) Inventors: Michael F. Fallon, Tiverton, RI (US); Myles J. Wilde, Charlestown, MA (US); Matthew Adiletta, Bolton, MA (US)

(21) Appl. No.: 13/538,372

(22) Filed: Jun. 29, 2012

(51) Int. Cl. G06F 3/12

(52) U.S. Cl. 358/1.15

(57) ABSTRACT

A method and system for printing information from a remote source is describes herein. The system includes a printer configured to directly access an information source, obtain information from the information source, and print the information.

### BACKGROUND

The methods and systems disclosed herein relate to the printing of documents from a remote source. More specifically, a printing system that is capable of printing information obtained from a remote server is disclosed.

Traditionally, the process of receiving documents has relied on postage stamp based mail. This method of communication can be slow, as it often took a few days for items to be delivered. In recent years, society has slowly moved toward the use of the faster electronic mail, or e-mail, to deliver and receive documents. However, an e-mail system still presents a few disadvantages. Within an e-mail inbox, documents such as billing statements and periodicals can be difficult to find among a clutter of personal messages, advertisements, and other communications. Further, a user must log in to the system to see e-mail messages.

Alternatively, a user may retrieve a document by logging on to a website, searching for a file, and downloading it. For a person who has to seek out multiple documents from multiple websites on a regular basis, this method can be time-consuming and frustrating, as the user will need to track multiple website accounts and must also remember to log in periodically.

### BRIEF DESCRIPTION OF THE DRAWINGS

FIG. 1 is a block diagram of a printing system configured to obtain information from a remote server on a network.

FIG. 2 is a block diagram of a multi-function printer configured to access information from a remote source.

FIG. 3 is a process flow diagram illustrating a method to print information from a remote source.

FIG. 4 is a process flow diagram illustrating a method to obtain information from a remote source using a pull function.

FIG. 5 is a process flow diagram illustrating a method to obtain information from a remote source using a push function.

### DESCRIPTION OF THE EMBODIMENTS

According to embodiments disclosed herein, a print system is used as a means of accessing, obtaining, and printing information from a remote source without requiring the intervention of a computer. The remote source, as used herein, may include a database or server that can be accessed through a local area network (LAN), wide area network (WAN), or the Internet, among others. Examples of the information that may be obtained may include, but is not limited to, online bank statements, news, periodicals, and e-mails on a remote server.

The print system may use two methods to obtain information, a pull function and a push function. In the pull function, the print system obtains the information by contacting the remote source and downloading the information for printing. In the push function, the remote source sends out information to the print system, which can recognize and download it for printing. The print system is capable of being configured so that both of these functions may be automatically performed at a regular scheduled basis.

Although some embodiments have been described in reference to particular implementations, other implementations are possible according to some embodiments. Additionally, the arrangement and order of circuit elements or other features illustrated in the drawings or described herein need not be arranged in the particular way illustrated and described. Many other arrangements are possible according to some embodiments.

In each system shown in a figure, the elements in some cases may each have a same reference number or a different reference number to suggest that the elements represented could be different or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An embodiment is an implementation or example of the invention. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

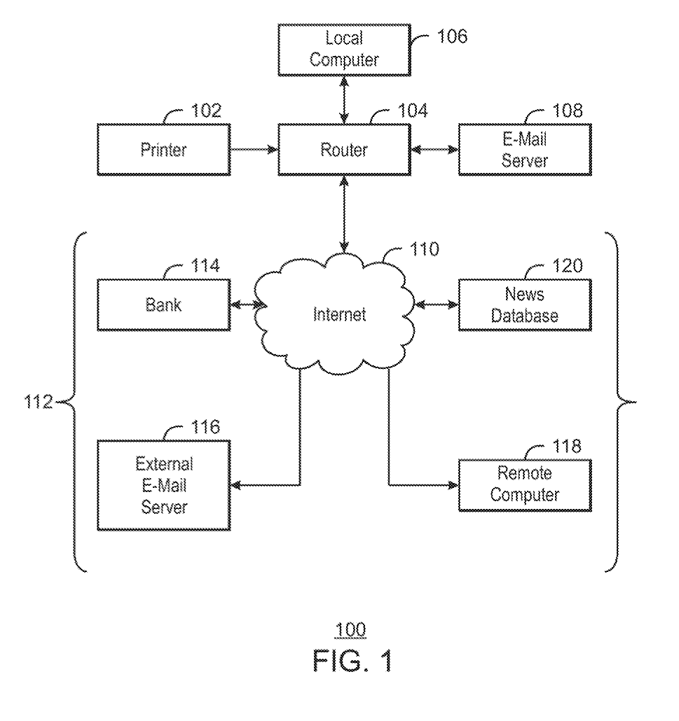

FIG. 1 is a block diagram of a printing system configured to directly obtain information from a remote server on a network. The printing system 100 may include a printer 102 connected to a router 104. The router 104 may provide the printer 102 and any other devices connected to it, such as a local computer 106 or an e-mail server 108, access to the Internet 110. It is to be understood that while the local computer 106 and e-mail server 108 are illustrated in FIG. 1, neither are necessary for the printing system to function. The printer 102 is able to access the Internet 110 either through the router or through a direct network connection.

The Internet 110 provides a channel in which a number of information sources and services in a cloud 112 may be accessed. Once connected to the Internet 110, the printer 102 may be able to obtain and print information from a remote information source, such as a bank 114, an external e-mail server 116, a remote computer 118, or a news database 120.

It is to be understood that the block diagram of FIG. 1 is not intended to indicate that the printing system 100 is to include all of the elements as shown in FIG. 1. Rather, the printing system 100 may include fewer or additional elements not illustrated in FIG. 1. The servers that are accessible in the cloud 112 are not limited to just those shown in FIG. 1. Any number of Internet enabled devices may be connected to the router 104.

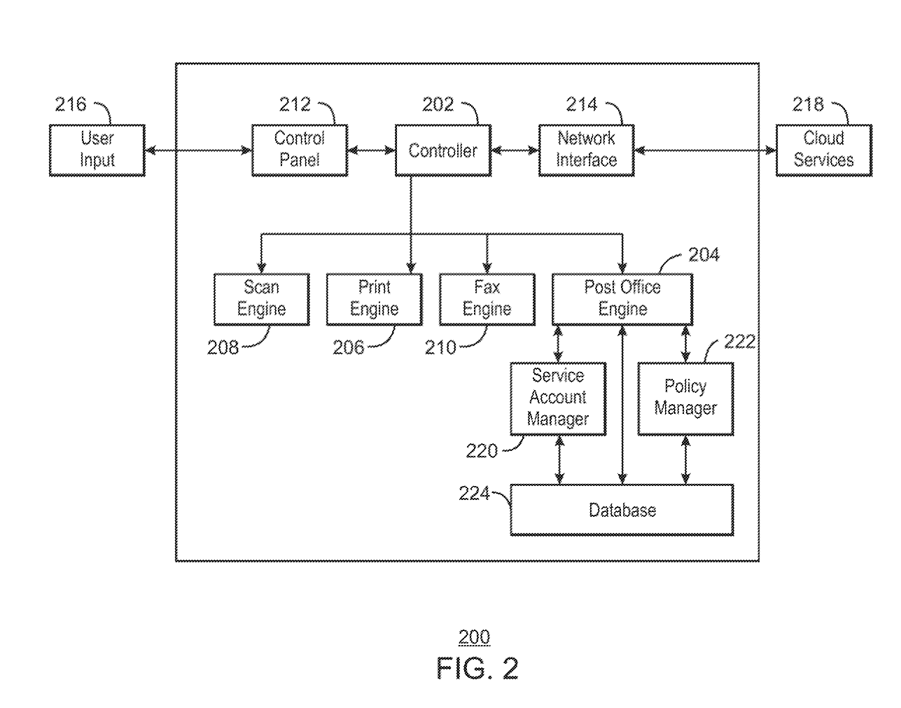

FIG. 2 is a block diagram of a multi-function printer configured to access information from a remote source. In addition to printing capabilities, the multi-function printer 200 may also feature scanning and faxing capabilities, among others. The multi-function printer 200 may comprise a controller 202 that controls and manages the activities of the other components, which may include a post office engine 204, a print engine 206, a scan engine 208, a fax engine 210, a control panel 212, and a network interface 214.

The control panel 212 may serve as an interface for a user to interact with the multi-function printer 200. It may accept user input 216 and translate it into a command to be processed by the controller 202, which in turn relays the command to the appropriate engine. The control panel 216 may feature a display screen with physical buttons or a touchscreen, among others. The controller may also be given user input and commands through the network interface 214, for example, from a local or remote computer.

The network interface 214 allows the multi-function printer 200 to access cloud services 218. This may include accessing any number of remote servers and databases existing on the Internet 110, for example, under the control of user input from the control panel 212. The network interface may be connected to the cloud services 218 through standard wired or wireless network interfaces.

The post office engine 204 is responsible for the functions and activities associated with accessing information from a remote source. It may orchestrate secure communications with the cloud services through the network interface 214. It may also send documents to the print engine 206 or the fax engine 208, and receive documents from the scan engine 208. Additionally, it may control the services of a service account manager 220 and a policy manager 222. Furthermore, it may update documents to a database 224, and retrieve documents from the database 224.

The service account manager 220 is responsible for performing the functions and managing the information required to connect to the cloud services 218 and access server-based account information. For example, the service account manager 220 may seek out a server on the Internet 200 to retrieve the information. The service account manager 220 can provide the user's authentication credentials needed to access the user's account, and download the target information. The service account manager 220 may also provide the multi-function printer 200 with a unique identifier, such as an IP address, so that cloud services 218 can identify and automatically send information to it.

The policy manager 222 is responsible for managing a set of rules for each configured account. The rules may dictate when information should be pulled from servers, and how to handle information provided by the servers. In one embodiment, the policy manager 222 may instruct the controller 202 to use the post office engine 204 to request information from the server twice a month, and automatically print all newly downloaded documents. In another embodiment, the policy manager 222 could request that all documents pushed to the multi-function printer 200 by a server be archived but not automatically printed.

The database 224 serves as a local storage area for printer data. In this embodiment, the database 224 would store policy rules, account information, and documents obtained from the cloud services 218, among others. The database 224 may also encrypt the local printer data if security measures are necessary.

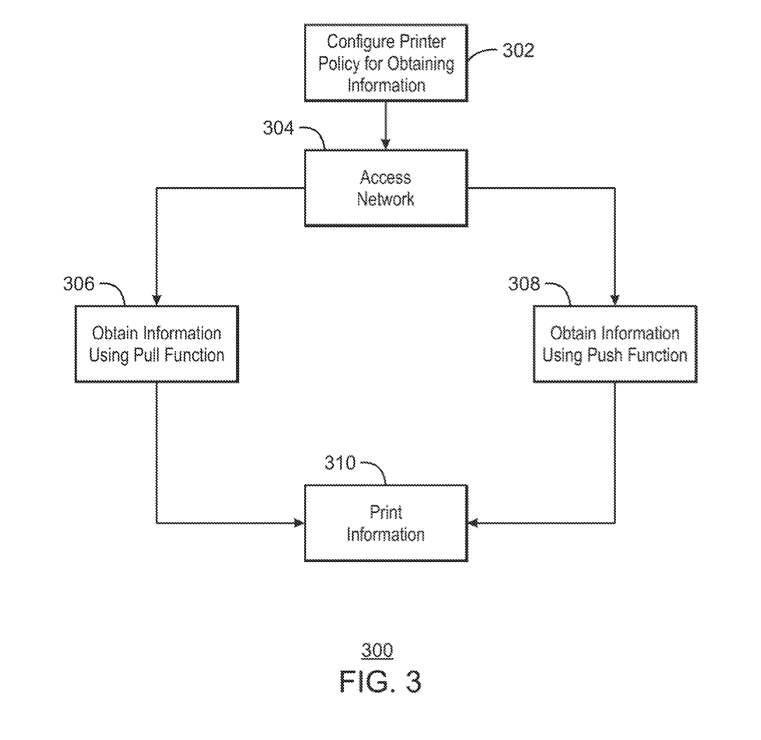

FIG. 3 is a process flow diagram illustrating a method to print information from the remote source. The method 300 may be executed by the printing system 100 illustrated in FIG. 1 using the multi-function printer 200 of FIG. 2.

At block 302, a policy for obtaining information is configured. The policy may constitute a set of rules that may include when information should be obtained from servers and how that information is utilized. The policy information may also include web-site addresses and account information, such as account names and passwords. One embodiment of a policy may dictate that the printing system should obtain a billing statement from a server once each week and print the statement automatically. Another embodiment may include electing to archive or fax the information upon download. The policy may be set by the policy manager of the multi-function printer 200 and stored in its database. In another embodiment, the policy may be configured to allow the user to perform the information-gathering process manually.

At block 304, the multi-function printer accesses a network to contact the information sources. The printer may locate an information source sought by the policy, and from there, may extract the information using one of two functions.

At block 306, the multi-function printer obtains the information from a remote server, e.g., using the pull function. For example, the multi-function printer may sign on to an account on a remote server, such as an e-mail account or a bank account, and download a document. In other embodiments, the remote server may be configured to provide the document upon receiving a properly credentialed request. In this embodiment, the multi-function printer may send a request to the source for a document. The source may respond by providing the document to the multi-function printer.

At block 308, a document is automatically sent to the printer, e.g., using a push function. Rather than have the multi-function printer obtain the document directly, or request that the source send a document, the source may automatically send the document to the multi-function printer instead. The multi-function printer may choose to accept the document, e.g., depending on policy and memory available.

At block 310, the multi-function printer prints the document that has been obtained through either the pull or push function. The multi-function printer may print the document on paper or fax it to a remote fax machine. Alternatively, it may also archive the document in the database of the multi-function printer, or send it to an external storage unit such as a computer or an external hard drive.

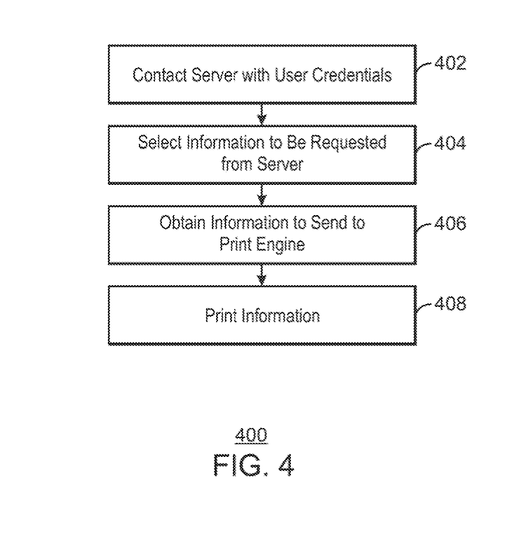

FIG. 4 is a process flow diagram illustrating a method to obtain information directly from the remote source, e.g., using the pull function. This method 400 may be executed manually by the user. Alternatively, the multi-function printer 200 can be configured with the policy manager to run this routine to pull information from a database on a regular scheduled basis.

At block 402, the multi-function printer contacts a server at an IP address to request access. If the server has restricted usage, the service account manager in the multi-function printer may provide user authentication credentials. The multi-function printer may also allow the user to enter account login information if the user is performing this function manually.

At block 404, the multi-function printer selects which information is to be obtained from the server. The multi-function printer may be configured to automatically search for and detect updated files of a certain category, or it may allow the user to browse the server through the control panel.

At block 406, the multi-function printer retrieves the requested information from the server. The information obtained may then be directed to the print engine by the controller. Alternatively, per configured policy or user request, the information may also be sent to the fax engine, the database, or to an external data storage.

At block 408, the multi-function printer prints out the information on paper. Alternatively, the information may also be faxed to another fax machine, archived in the database, or sent to the external data storage.

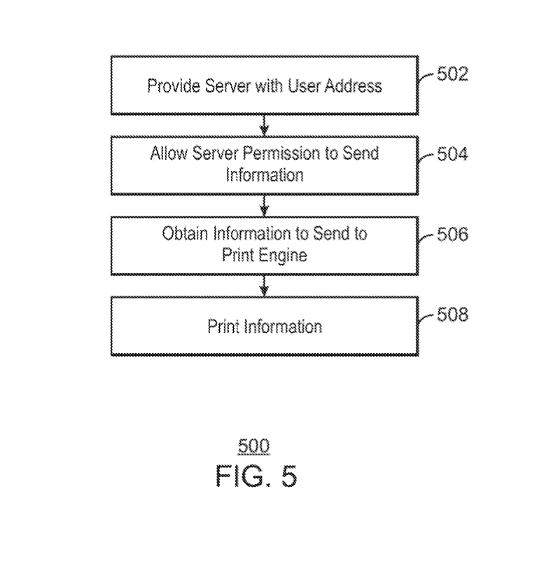

FIG. 5 is a process flow diagram illustrating a method to obtain information from the remote source using the push function. In this method 500, a server directly provides the information to the multi-function printer. Using this method, the multi-function printer may receive and print all information pushed out to it. Alternatively, a policy may be configured by the policy manager so that only information from certain servers can be received by the multi-function printer.

At block 502, the multi-function printer provides the server with a unique identifier, such as an e-mail address or IP address. The identifier can be provided by the service account manager, and gives the server a destination to send the information.

At block 504, the multi-function printer allows the server permission to send the information. A policy may be configured so that the server must provide credentials before being given permission, so that unwanted communication such as advertisements, spam, or messages from unidentified sources may be automatically blocked. Furthermore, the policy may also limit the information to a certain size or category, in order to filter out excess or unwanted data. This step may also be performed manually by the user, where the user can preview the information through the control panel and choose to download it or decline it.

At block 506, the, multi-function printer receives the delivered information from the server. The obtained information may be directed to the print engine. Alternatively, per configured policy or user request, the information may also be sent to the fax engine, the database, or to external data storage.

At block 508, the multi-function printer prints out the information on paper. Alternatively, the information may also be faxed to another fax machine, archived in the database, or sent to the external data storage.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A printing system, comprising a printer that directly accesses an information source, obtain information from the information source, and print the information.

2. The printing system of claim 1, wherein the printer pulls information from the information source.

3. The printing system of claim 1, wherein the printer receives information pushed to it from the information source.

4. A printer for printing information from a remote source, comprising:
a post office engine that directly obtain information from the remote source;
a controller that directs the post office engine to obtain the information from the remote source, and pass the information to a print engine; and
the print engine that prints the information.

5. The printer of claim 4, further comprising a database that stores the information provided by the remote source.

6. The printer of claim 5, further comprising a service account manager that provides account information needed to access the information source, wherein the account information is stored in the database.

7. The printer of claim 5, further comprising a policy manager that sets a policy for accessing information from the information source, wherein the policy is stored in the database.

8. The printer of claim 4, further comprising a control panel that receives a user input.

9. The printer of claim 4, further comprising a network interface that allows the printer to communicate with a network.

10. The printer of claim 4, further comprising a scan engine.

11. The printer of claim 4, further comprising a fax engine.

12. A method to print information from a remote source, comprising:
activating a post office engine in a printer, wherein the post office engine accesses information from the remote source;
formatting the information for printing; and
printing the information.

13. The method of claim 12, further comprising providing the remote source with a set of user credentials.

14. The method of claim 12, wherein the information from the remote source can be pulled at periodic intervals automatically.

15. The method of claim 12, further comprising receiving information pushed out from the remote source.

16. The method of claim 15, further comprising providing the remote source with a user address.

17. The method of claim 15, wherein the information from the remote source can be pushed out at periodic intervals automatically:

18. The method of claim 15, wherein the post office engine declines accepting information pushed out from the remote source.

19. The method of claim 12, further comprising archiving the information.

20. The method of claim 12, further comprising faxing the information.
